(19) United States
(12) Patent Application Publication
(10) Pub. No.: US 2006/0181038 A1
(43) Pub. Date: Aug. 17, 2006

(54) Sled with wind brace

(75) Inventor: Thomas A. Walter, Cologne, MN (US)

Correspondence Address: Dicke, Billig & Czaja, PLLC, Fifth Street Towers, Suite 2250, 100 South Fifth Street, Minneapolis, MN, 55402, US

(73) Assignee: Clam Corporation, Plymouth, MN (US)

(21) Appl. No.: 11/047,396

(22) Filed: Jan. 31, 2005

(51) Int. Cl. B62B 13/00

(52) U.S. Cl. 280/19.1

(57) ABSTRACT

A portable shelter comprises a sled, a first bracket, a first pole, and a first sheet of material. The sled includes a base and a plurality of walls connected to the base, and the plurality of walls include a perimeter edge. The first bracket is disposed on the sled. The first pole has a first end and a second end, where the first end of the first pole is operatively connected to the first bracket. The first pole is pivotable between a first position where the second end of the first pole is positioned adjacent to a first portion of the perimeter edge and a second position where the second end of the first pole is spaced from the first portion of the perimeter edge. The first sheet of material is secured between the first pole and the portion of the perimeter edge of the sled, such that the sled can be positioned to rest on a bottom edge of the edge portion with the sled tilted at an angle defined by the first sheet. Further disclosed is a method of converting a shelter assembly between a sled mode and a shelter mode.

### BACKGROUND OF THE INVENTION

In northern climates, when cold winter temperatures turn lake surfaces into ice, many anglers brave cold and wind for the time honored sport of ice fishing. Often times, the only difference between cold and comfort is avoiding the wind. A simple, inexpensive means for providing shelter in conjunction with activities such as ice fishing is needed.

### BRIEF SUMMARY OF THE INVENTION

A portable shelter according to the present invention comprises a sled, a first bracket, a first pole, and a first sheet of material. The sled includes a base and a plurality of walls connected to the base, and the plurality of walls include a perimeter edge. The first bracket is disposed on the sled. The first pole has a first end and a second end, where the first end of the first pole is operatively connected to the first bracket. The first pole is pivotable between a first position where the second end of the first pole is positioned adjacent to a first portion of the perimeter edge and a second position where the second end of the first pole is spaced from the first portion of the perimeter edge. The first sheet of material is secured between the first pole and the portion of the perimeter edge of the sled, such that the sled can be positioned to rest on a bottom edge of the edge portion with the sled tilted at an angle defined by the first sheet.

### BRIEF DESCRIPTION OF THE DRAWINGS

FIG. 1 is a perspective view of an embodiment of a portable shelter of the present invention.

FIG. 2 is a side elevational view of the portable shelter of FIG. 1.

FIG. 3 is an enlarged exploded cross-sectional view of an edge portion of a sled of the portable shelter of the present invention.

FIG. 4 is a perspective view of the portable shelter in a sled mode.

### DETAILED DESCRIPTION

The present invention relates to a portable shelter. The portable shelter includes a sled and one or more wing assemblies. The sled can be used for carrying and transporting supplies and equipment. The sled can also be placed upright and supported at a tilted angle by the one or more wing assemblies for creating a shelter that functions as a wind brace (or wind break). The portable shelter is convertible simply between a sled mode and a shelter mode.

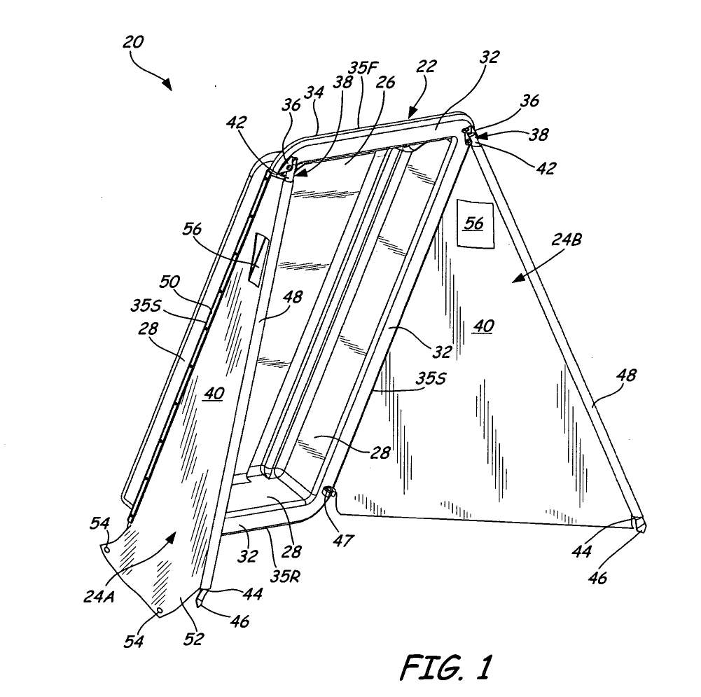

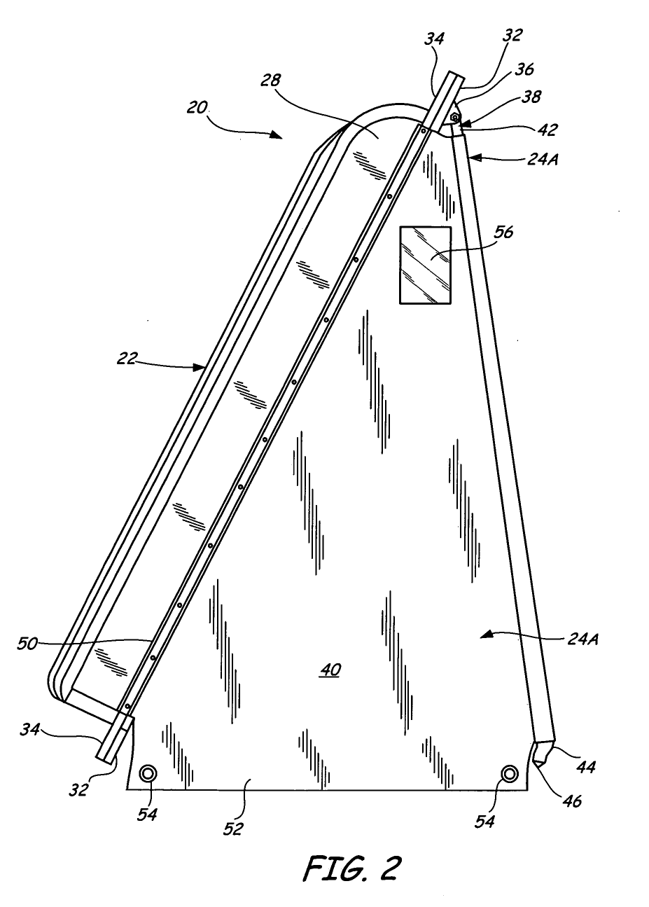

FIG. 1 is a perspective view of an embodiment of a portable shelter 20 in a shelter mode. FIG. 2 is a side elevational view of the portable shelter 20 in the shelter mode. As shown in FIG. 1, the portable shelter 20 generally includes a sled 22 and first and second wing assemblies 24A and 24B.

The sled 22 is constructed from a suitable polymer, such as in a molding process that yields a base 26 and perimeter side walls 28 extending from the base 26. An outwardly radiating upper perimeter ledge 32 extends generally normal to the side walls 28. The ledge 32 is further connected to a perimeter lip 34, which extends generally normal to the ledge 32 and toward the base 26. The sled 22 has a generally rectangular shape, with two shorter sides, front side 35F and rear side 35R, and two longer sides 35S. As shown best in FIG. 2, base 26 at a front side 35F of the sled 22 is slanted or radiused to facilitate sliding the sled 22 over snowy and icy terrain.

The wing assemblies 24A and 24B are identically constructed and will be discussed relative to wing assembly 24A. Wing assembly 24A generally comprises a U-shaped bracket 36, a pole 38, and a sheet of material 40. The U-shaped bracket 36 is mounted on the ledge 32 of the sled 22, and pivotally connects the pole 38 to sled 22. The bracket 36 is positioned near the front side 35F of the sled 22, and can be secured to ledge 32 using one or more bolts or similar fasteners.

The pole 38 has a first end 42 and a second end 44. The pole 38 can be adjustable in length. The first end 42 of the pole 38 is pivotally mounted to the U-shaped bracket 36 using a pivot pin or other similar connector. In one embodiment, the second end 44 of the pole 38 has a pointed tip 46. Those skilled in the art will recognize that the second end 44 of pole 38 is generally configured to securely engage or grip a ground surface that may be snowy and/or icy, and other gripping means, for example cleats, can be utilized. The pole 38 is pivotable between a first (closed) position, where the second end 44 of the pole 38 is positioned adjacent to a portion of the ledge 32 of the sled 22, and a second (open) position where the second end 44 of the pole 38 is spaced from the portion of the ledge 32. A pair of C-shaped brackets 47 (only one bracket visible in FIG. 1) are attached to the ledge 32 along each side 35S near rear side 35R, for securing the pole 38 of each wing assembly 24A, 24B therein. An angular range of travel of the pole 38 is defined by dimensions of the sheet of material 40. In FIG. 1 the pole 38 is shown in the second (open) position, with the second end 44 spaced from the ledge 32 of the sled 22 to hold the sheet of material 40 in the opened position.

The sheet of material 40 comprises any suitable fabric. By way of example, material 40 can comprise a fabric selected for properties such as flexibility in cold temperatures, durability, weather resistance and wind-stopping capability. One suitable fabric is ICE ARMOR™ fabric by Clam Corp., Minneapolis, Minn. The sheet of material 40 has a generally triangular shape. The sheet of material 40 has a first elongate edge that is configured to define a sleeve 48 for securing the sheet of material 40 to the pole 38. The sheet of material 40 further includes a second elongate edge connected to the lip 34 along a longer side 35S of the sled 22 by a bracket 50. Fasteners, such as screws, bolts or the like, can be used to secure the bracket 50 to the lip 34. Such fasteners generally penetrate the sheet of material 40.

The pole 38 in the second (open) position holds the sheet of material 40 in an open, substantially planar configuration, and supports the sled 22 in a tilted, upright position. In this position the ledge 32/lip 34, at a rear end 35R of the sled 22, are in contact with the ground surface.

In further embodiments, the wing assemblies 24A and 24B can include various optional features. In one embodiment, a flap or skirt 52 (not shown with respect to wing assembly 24B) having one or more grommets 54 can extend from a bottom edge of the sheet of material 40. In still further embodiments, a window 56 is disposed in the sheet of material 40. The flap or skirt 52 can be a separate piece of material connected to the sheet of material 40 or merely formed as a contiguous extension of the sheet of material 40 itself. The flap 52 makes the functional length of the sheet of material 40 (measured along the second elongate edge of the sheet of material 40) longer than the sled 22 (measured along one of the longer sides of the sled 22). The one or more grommets 54 are used for securing the flap 52 to a ground surface (that may be snowy and/or icy) using stakes, anchors, or the like. The window 56 can be disposed in the sheet of material 40, and can be a clear vinyl material. Other features such as pockets located on an inside face of the sheet of material 40 and safety reflectors located on an outside face of the sheet of material 40 can also be included.

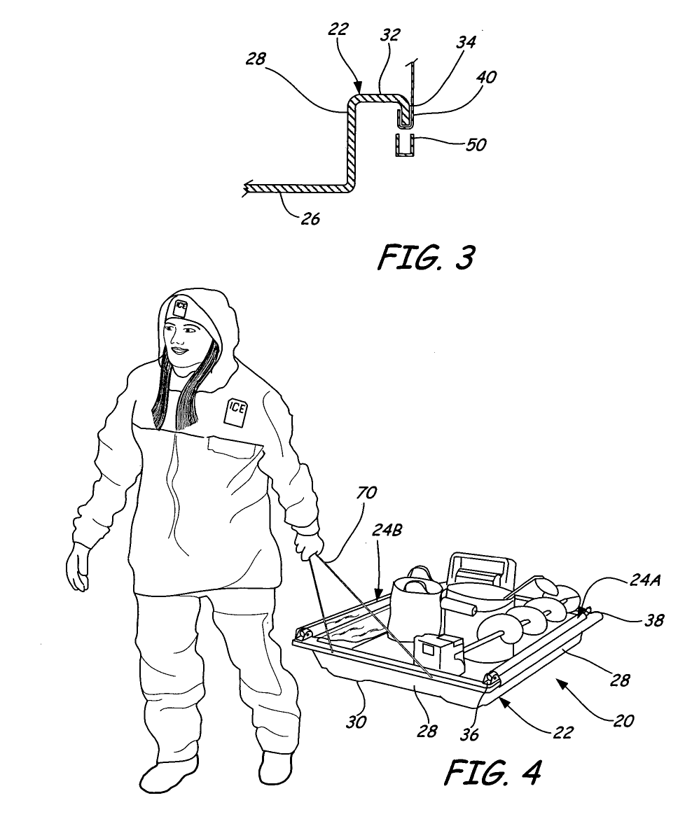

FIG. 3 is an enlarged exploded cross-sectional view of an edge portion of the sled 22. As shown in this embodiment, bracket 50 comprises an elongate U-shaped channel sized to fit over the lip 34 with a portion of the sheet of material 40 disposed therebetween for frictionally securing the second elongate edge of the sheet of material 40 to the lip 34. As described above, bracket 50 can be secured to the sled 22 with suitable fasteners that engage the bracket 50, the sheet of material 40, and the lip 34.

FIG. 4 is a perspective view of the shelter 20 in a sled mode. As shown in FIG. 4, the shelter 20 further includes towing means 70. Towing means 70 can be a rope, bar, hitch, harness, grip, yoke, link, tie, handle, linkage, or other device or structure for pulling the shelter 20. In the sled mode, the poles 38 are in a first (closed) position, adjacent the ledge 32 of the sled 22. Supplies and equipment can be placed within an open space created between the walls 28 of the sled 22 for storage and transportation.

In further embodiments, a cover (not shown) can be fitted over the shelter 20, while in the sled mode, for covering an open portion of the sled 22 as well as supplies and equipment stored there. In still further embodiments, skis or runners can be fitted to or formed along outer portions of the base 26 of the sled 22 to facilitate sliding the shelter 20 over snowy and icy terrain.

The shelter is convertible to the shelter mode (shown in FIG. 1) from the sled mode (shown in FIG. 4) by first removing equipment and supplies stored in the sled 22. Then the sled 22 is positioned upright to rest on the ground surface at the rear side 35R of the sled 22. The wing assemblies 24A and 24B are deployed by rotating the poles 38 about the brackets 36, such that the second ends 46 of the poles 38 are spaced from the sled 22 in second (open) positions. The poles 38 are positioned to support the sled 22 tilted at an angle defined by the sheets of material 40. The poles 38 are secured to the ground surface, such as by penetrating the ground surface with the pointed tips 46. A tent-like sheltered area is created by the sled 22 and the wing assemblies 24A and 24B for shielding and protecting a user from environmental conditions, such as wind. The user can position the shelter 20 in such a way that the sled 22 and wing assemblies 24A and 24B provide optimum protection from environmental conditions (e.g., by orienting the entire shelter 20 appropriately relative to oncoming wind or precipitation). The flaps or skirts 52 can then be secured to the ground surface by placing spikes, anchors, etc., through the grommets 54.

In a similar fashion, the shelter 20 can be converted from the shelter mode to the sled mode by following the procedure described above in reverse. When the wing assemblies 24A and 24B are closed, the sheets of material 40 are stowed inside the sled 22. The respective pole 38 of each wing assembly 24A, 24B is secured to the C-shaped clamps 47 (shown in FIG. 1) on the ledge 32 of the sled 22.

In further embodiments, a shelter according to the present invention includes only a single wing assembly for supporting a sled in an upright, tilted position. In such an embodiment, the shelter is configured and operated in a similar manner to that described above. A sheltered area is created between the single wing assembly and the sled, and the single wing assembly alone supports the sled in a tilted, upright position.

Thus it will be recognized that the present invention provides a simple, lightweight, and inexpensive shelter than is convertible between a sled mode and a shelter mode.

Although the present invention has been described with reference to preferred embodiments, workers skilled in the art will recognize that changes may be made in form and detail without departing from the spirit and scope of the invention.

1. A portable shelter comprising:
a sled comprising a base and a plurality of walls connected to the base, the plurality of walls comprising a perimeter edge;
a first bracket disposed on the sled;
a first pole having a first end and a second end, the first end of the first pole being operatively connected to the first bracket, and the first pole being pivotable between a first position where the second end of the first pole is positioned adjacent to a first portion of the perimeter edge and a second position where the second end of the first pole is spaced from the first portion of the perimeter edge; and
a first sheet of material secured between the first pole and the portion of the perimeter edge of the sled, wherein the sled can be positioned to rest on a bottom edge of the edge portion with the sled tilted at an angle defined by the first sheet.

2. The portable shelter of claim 1 and further comprising a flap of material connected to the sheet of material, wherein the flap is disposed distal to the first bracket.

3. The portable shelter of claim 1, wherein a window is disposed in the first sheet.

4. The portable shelter of claim 1, wherein the first sheet of material comprises a fabric material.

5. The portable shelter of claim 1, wherein the first sheet of material is formed in a triangular shape.

6. The portable shelter of claim 1 and further comprising:
a second bracket disposed on the sled;
a second pole having a first end and a second end, the first end of the second pole being operatively connected to the second bracket, and the second pole being pivotable between a first position where the second end of the second pole is positioned adjacent to a second portion of the perimeter edge and a second position where the second end of the second pole is spaced from the second portion of the perimeter edge of the sled; and
a second sheet capable of being secured between the second pole and the edge portion of the sled.

7. The portable shelter of claim 1, and further comprising towing means for pulling the portable shelter.

8. The portable shelter of claim 1, wherein the perimeter edge comprises a first surface generally normal to the plurality of walls and a lip generally normal to the first surface.

9. The portable shelter of claim 8, wherein the first sheet of material comprises a first elongate edge configured to define a sleeve, the first pole positioned in the sleeve, and a second elongate edge positioned over the lip of the perimeter edge of the sled, and means for securing the second elongate edge to the lip.

10. The portable shelter of claim 1, wherein the second end of the first pole comprises a pointed tip.

11. The portable shelter of claim 1, wherein the first bracket in located at a front end of the sled.

12. The portable shelter of claim 1, wherein the first bracket is located on the perimeter edge of the sled.

13. A method of converting a shelter assembly between a sled mode and a shelter mode wherein the shelter assembly includes a sled, a first and a second bracket, a first and a second pole, and a first and a second fabric sheet, wherein the first pole is operatively connected to the first bracket and the second pole is operatively connected to the second bracket, and wherein the first fabric sheet is disposed substantially between the first pole and the sled and the second fabric sheet is disposed substantially between the second pole and the sled, the method comprising:
positioning the sled to rest on a ground surface at a bottom portion of a perimeter edge of the sled;
rotating the first and second poles about the first and the second brackets, respectively, such that portions of the first and the second poles are spaced from the sled; and
positioning the first and second poles to support the sled at an angle defined by the first and the second fabric sheets.

14. A portable shelter comprising:
a sled comprising a base and a plurality of walls connected to the base, the plurality of walls comprising a perimeter edge;
a pair of spaced brackets disposed on a front end of the sled;
a pair of poles each pivotably connected to one of the spaced brackets, wherein the pair of poles are pivotable between first positions where the pair of poles are positioned adjacent to the sled and second positions where portions of the pair of poles are spaced from the sled, and wherein the pair of poles support the sled in an upright position;
a pair of sheets of material that define the spacing of the pair of poles from the sled.

15. The portable shelter of claim 14 and further comprising a flap connected to one of the sheets of material, wherein the flap is disposed distal to the front end of the sled.

16. The portable shelter of claim 14, wherein the first sheet of material is formed in a triangular shape.

17. The portable shelter of claim 14, and further comprising towing means for pulling the portable shelter.

18. The portable shelter of claim 14, wherein at least one of the pair of poles comprises a pointed tip.
